(19) United States
(12) Patent Application Publication
(10) Pub. No.: US 2003/0136209 A1
(43) Pub. Date: Jul. 24, 2003

(54) Powershift transmission with hydrodynamical and mechanical power distribution

(76) Inventor: Tilo Huber, Passau (DE)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/340,911

(22) Filed: Jan. 10, 2003

(30) Foreign Application Priority Data
Jan. 18, 2002 (DE) 102 01 837.5

(51) Int. Cl. F16H 3/08

(52) U.S. Cl. 74/331

(57) ABSTRACT

A powershift transmission (1) having hydrodynamical and mechanical power distribution, especially one such multi-gear powershift transmission as a reversing transmission for construction machinery, with at least one output shaft (35) and several countershafts (6, 7, 8, 9, 10) having idler wheels, fixed wheels and gear clutches, which form several countershaft units (KR, KV, K1, K2, K3, K4) for gear and direction shifting distributed thereon, and at least two input shafts (2, 4), one of the input shafts (2) being connected with a turbine section of a torque converter and a second input shaft (4) being connected via the direct through drive with the rotational speed of an engine, the countershaft unit (K4) being designed as a mechanical range change group subdivided by the countershafts (K1, K2, K3).

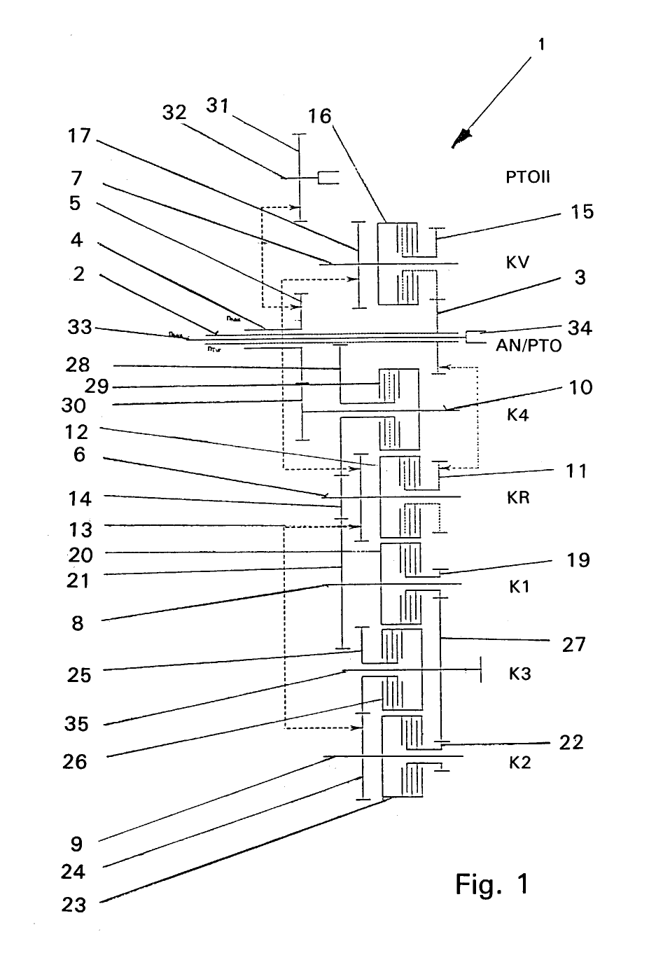

According to the preamble of claim 1, the invention relates to a multi-gear powershift transmission with a hydrodynamical and a mechanical power distribution, in particular, one such multi-gear powershift transmission as a reversing transmission for construction machinery.

Powershift reversing transmissions are used in many different vehicles of the construction machinery branch. Typical examples of use are in forklift trucks, excavator and wheel loaders, telescopic handlers and also mobile cranes. The multiplicity of vehicles in this area requires a great amount of adaptation capacity in the used transmission, since the installation and utilization conditions in different vehicles can be widely different.

The installation space available, for example, can be extremely small. There can also appear different center distances between the transmission input shaft and the transmission output shaft. Depending upon the type of vehicle, a specific center distance is accordingly required between the input and output shafts of the transmission. Besides, in most areas of utilization at least one power take-off unit is needed, for example, for the hydraulic system of the mobile machinery. The functions that a reversing transmission has to perform are accordingly very differently determined by the type of construction of the vehicle. These requirements must be met within the axial length and width of the transmission. A future requirement on powershift transmissions with hydrodynamical power distribution will also be an improved degree of effectiveness mainly when used with high services. In many utilizations, an additional mechanical power distribution can be an alternative to an often costly converter lock-up clutch.

U.S. Pat. No. 6,186,020 B1 has disclosed a powershift reversing transmission having a first part with first and second input shafts and one output shaft. The first input shaft of this prior art can be combined with a pump section of a torque converter whereas the second input shaft can optionally be combined with a turbine section of a torque converter so that it is possible to select separate drive paths with powershift clutches, via the torque converter or via a direct through drive from an engine to a transmission output. The drive path via the turbine section of the torque converter is designated as a hydrodynamical power distribution and the drive path via the direct through drive, as a mechanical power distribution. A second part of the transmission of this prior art has clutches and gear elements for different forward and reverse gears of the powershift reversing transmission. Said transmission of the prior art can also be operated as a retarder. By the arrangement of gear clutches, fixed wheels and idler wheels on several countershafts of this prior art, long and short center distances can be implemented, different combinations of countershafts taking part in the power transmission according to the gear desired. Accordingly, for implementing in this prior art center distances different from each other, shaft arrangements different from each other are provided, but in this prior art, the limited flexibility of the gear ratios and of the total ratio is disadvantageous, the latter being quite low. Besides, the flexibility of the center distances, of the arrangement of input and output and of the PTO is not satisfactory.

The problem to be solved by this invention is to provide an efficient, multi-gear powershift transmission with a hydrodynamical and a mechanical power distribution at low cost which can be adapted to different installation situations, has an arrangement of shafts that is flexible and thus suitable for bridging different center distances and requires only a few added parts for adaptation to a specific installation situation.

On the basis of a multi-gear powershift transmission with hydrodynamical and mechanical power distribution of the type above mentioned in detail, this problem is solved with the features stated in the characteristic part of the claims.

According to the invention, a powershift transmission with a hydrodynamical and a mechanical power distribution is provided, especially one such multi-gear powershift transmission as a reversing transmission for construction machinery. At least one output shaft and several countershafts having idler wheels, fixed wheels and gear clutches distributed thereon form several countershaft units for shifting gear and direction. At least two input shafts are provided: one of said input shafts is connected with a turbine section of a torque converter and belongs to the hydrodynamical power distribution and a second input shaft is connected, via the direct through drive, with the rotational speed of an engine and belongs to the mechanical power distribution. According to the invention, one countershaft unit K4 is designed as a mechanical range change group which is subdivided by countershaft units K1, K2, K3. With the inventive powershift transmission, with the reduced number of parts and thus reduced construction expense, the flexibility of the gear ratios is improved and the total ratio increased in comparison with the prior art cited.

According to a preferred development of the invention, during operation of the countershaft unit K4, the turbine section of the torque converter is separated from the output shaft so that losses from the torque converter are prevented and the degree of efficiency of the inventive powershift transmission is improved.

According to another preferred development of the invention, the ratio of the highest gear of the hydrodynamical range (third gear=KV+K3) is equal to the ratio of the lowest gear of the mechanical range (fourth gear=K4+K1) so that upon a range change, despite the dual clutch change, the clutch control is simplified and optimal shifting quality is ensured.

According to a preferred embodiment of the invention, the powershift transmission has a power take-off, such as a PTO, coaxially to the input shafts. An engine-dependent power take-off is preferably used.

The individual shafts of the inventive powershift transmission are combined to form one reversing transmission unit KV, KR, K4 and one gear transmission unit K1, K2, K3, the reversing transmission unit being provided on any desired side of the input shaft and the gear transmission unit attaching to the reversing transmission unit so that the reversing transmission unit and the gear transmission unit, in relation to the input shaft, are consecutively disposed on one side of the output shaft. The gear transmission unit preferably attaches to the countershaft unit of the reverse gear.

The flexible arrangement of the shafts can be obtained without having to exchange the components involved in the power flow. A maximum possibility of re-use of the components is thus ensured.

For vehicles which require the bridging of great distances from the transmission, a long distance variant is provided such as can be implemented with a power divider transmission.

In one other preferred embodiment of the invention, the countershaft unit of the fourth gear is disposed next to the input shafts independently of the other countershaft units. Said countershaft unit also can be eliminated when needed from the inventive powershift transmission. Such a construction of the transmission can be considered, for example, for forklift trucks which, as a rule, have only three different gears available. The transmission is then only driven via the hydrodynamical power distribution. The space gained by the removed countershaft unit can be used for an added power take-off.

Accordingly, it is possible to go into the most different requirements of the transmission by the instant invention while retaining the basic draft. Material and expenses are saved, because of the standardization and the simple construction. Maintenance and servicing are also simpler by virtue of the standardization.

A preferred embodiment of the invention is explained in detail herebelow with reference to a drawing.

The single figure shows a transmission diagram of a multi-gear powershift transmission with hydrodynamical and mechanical power distribution according to this invention.

A multi-gear power transmission 1 has as input shafts an inner hollow shaft 2 with a fixed wheel 3 and an outer hollow shaft 4 with a fixed wheel 5. The inner hollow shaft 2 is driven by a turbine section of a torque converter (not shown) and belongs to a hydrodynamical power distribution and the outer hollow shaft 4 is driven via the direct through drive at the rotational speed of an engine (not shown) and belongs to a hydrodynamical power distribution.

The powershift transmission 1 has countershafts 6, 7, 8, 9, 10 upon which are respectively disposed fixed wheels, idler wheels and clutch elements forming with these several countershaft units. The countershaft unit for the reverse gear KR is formed by the countershaft 6, the idler wheel 11, the clutch element 12 and the fixed wheels 13, 14. The countershaft unit for the forward gear KV is formed by the countershaft 7, the idler wheel 15, the clutch element 16 and the fixed wheel 17. The countershaft unit for the first gear K1 is formed by the countershaft 8, the idler wheel 19, the clutch element 20 and the fixed wheel 21. The countershaft unit for the second gear K2 is formed by the countershaft 9, the idler wheel 22, the clutch element 23 and the fixed wheel 24. The countershaft unit of the third gear K3 is formed by the output shaft 35, the idler wheel 25, the clutch element 26 and the fixed wheel 27. The countershaft unit of the fourth gear K4 is formed by the countershaft 10, the idler wheel 28, the clutch element 29 and the fixed wheel 30. The countershaft 10 is preferably placed next to the inner and outer hollow shafts 2, 4 so that the fixed wheel 5 meshes with the fixed wheel 30.

The outer hollow shaft 4 preferably actuates another fixed wheel 31 to a take-off 32 to a PTO, which is disposed far in front on the transmission in order that a hydraulic pump (not shown) required for the vehicle or the transmission can be disposed parallel to the transmission. Thereby the necessary installation space for the transmission is reduced while the axial length decreases to a minimum. A central shaft 33 is likewise driven, by a direct through drive, to another power take-off 34 of an optimal additional PTO.

From the graph in the figure, the expert can easily understand the mode of operation of the gear wheels and clutches for shifting the different gears and the corresponding power flow. Therefore, this will not be further discussed here.

When the power flows via the hydrodynamical power distribution, the range change group IV is subdivided by the countershaft units K1, K2, K3 (gear 1V, 2V, 3V). Correspondingly the range change group K4, when the power flows via the mechanical power distribution is subdivided by the countershaft units K1, K2, K3 (gear 4V, 5V, 6V). The reverse gears are actuated by the range change group K$R only via the hydrodynamical power distribution. During operation, the turbine section of the torque converter is connected with the output 35 via the mechanical power distribution.

For the individual gears, the following clutches have to be engaged:

| | Clutches | | | |
|---|---|---|---|---|
| first forward gear: | | 16, 20 | | KV, K1 |
| second forward gear: | | 16, 23 | | KV, K2 |
| third forward gear: | | 16, 26 | | KV, K3 |
| fourth forward gear: | | 29, 20 | | K4, K1 |
| fifth forward gear: | | 29, 23 | | K4, K2 |
| sixth forward gear: | | 29, 26 | | K4, K3 |
| reverse gear | | 12, 20 | | KR, K1 |
| | or | 23 | or | K2 |
| | or | 26 | or | K3 |

When passing from the third forward gear to the fourth forward gear, preferably no ratio change occurs while then at five forward gears advantages can be obtained when synchronizing the range change with the hydrodynamical-mechanical power distribution.

The countershaft units KV, KR and K4 form a reversing transmission unit and the countershaft units K1, K2 and K3 form a gear transmission unit, the countershaft units of the reversing transmission unit are provided on one side next to the input shafts 2, 4 and the countershaft units of the gear transmission unit attach to the countershaft unit KR of the reverse gear.

Reference numerals

```
  1 powershift transmission
  2 input shaft
  3 fixed wheel
  4 input shaft
  5 fixed wheel
  6 countershaft
  7 countershaft
  8 countershaft
  9 countershaft
10 countershaft
11 idler wheel
12 clutch element
13 fixed wheel
14 fixed wheel
15 idler wheel
16 clutch element
17 fixed wheel
19 idler wheel
20 clutch element
21 fixed wheel
22 idler wheel
23 clutch element
24 fixed wheel
25 idler wheel
26 clutch element
27 fixed wheel
28 idler wheel
29 clutch element
30 fixed wheel
31 fixed wheel
32 power take-off
33 central shaft
33 power take-off
34 output shaft
KV countershaft unit forward gear
KR countershaft unit reverse gear
K1 countershaft unit first gear
K2 countershaft unit second gear
K3 countershaft unit third gear
K4 countershaft unit mechanical
  range change group
AN input shaft
```

1. Powershift transmission (1) with hydrodynamical and mechanical power distribution, especially one such multi-gear powershift transmission as reversing transmission for construction machinery having at least one output shaft (35) and several countershafts (6, 7, 8, 9, 10) and distributed thereon idler wheels, fixed wheels and gear clutches which form several countershaft units (KR, KV, K1, K2, K3, K4) for shifting gear and direction and at least two input shafts (2, 4), one of said input shafts (2) being connected with a turbine section of a torque converter and a second input shaft (4) being connected via the direct through drive with the rotational speed of an engine, characterized in that said countershaft unit (K4) is designed as mechanical range change group subdivided by said countershaft units (K1, K2, K3)

2. Powershift transmission (1) according to claim 1, characterized in that during operation of said countershaft unit (K4) the turbine section of the torque converter is separated from said output shaft (35).

3. Powershift transmission (1) according to claim 1, characterized in that the ratio of the highest gear of the hydrodynamical range (third gear=KV+K3) is equal to the ratio of the lowest gear of the mechanical range (fourth gear=K4+K1).

4. Powershift transmission (1) according to claim 1, characterized in that coaxially to said input shafts (2, 4) a power take-off (34) such as a PTO is provided.

5. Powershift transmission (1) according to claim 1, characterized in that the individual shafts are combined to form a reversing transmission unit (KV, KR, K4) and a gear transmission unit (K1, K2, K3), said reversing transmission unit being provided in any desired side of said input shafts (2, 4) and said gear transmission unit attaching to said reversing transmission unit so that said reversing transmission unit and said gear transmission unit, in relation to said input shafts (2, 4) are disposed consecutively upon one side of said input shafts.

6. Powershift transmission (1) according to any one of the preceding claims, characterized in that to said output shaft (35) a power divider transmission can be attached.

7. Powershift transmission (1) according to any one of the preceding claims, characterized in that the countershaft unit of the fourth gear (K4) is disposed next to said input shafts (2, 4) independently of the remaining countershaft units.

8. Powershift transmission (1) according to any one of the preceding claims, characterized in that the countershaft unit of the fourth gear (K4) can be removed without further changes from said powershift transmission (1).

9. Powershift transmission (1) according to any one of preceding claims, characterized in that a power take-off (32) is situated in parallel next to said input shaft (2, 4).

10. Powershift transmission (1) according to claim 9, characterized in that said power take-off (32) is engine dependent.

11. Powershift transmission (1) according to any one of the preceding claims, characterized in that a power take-off can be provided instead of the countershaft unit of the fourth gear (K4).
